(19) United States
(12) Patent Application Publication
(10) Pub. No.: US 2024/0142846 A1
(43) Pub. Date: May 2, 2024

(54) LIGHT PATH CONTROL DEVICE AND MANUFACTURING METHOD THEREOF

(71) Applicant: LG Display Co., Ltd., Seoul (KR)

(72) Inventors: Jaehyun PARK, Paju-si (KR); Eunhee CHOI, Paju-si (KR)

(73) Assignee: LG Display Co., Ltd., Seoul (KR)

(21) Appl. No.: 18/239,541

(22) Filed: Aug. 29, 2023

(30) Foreign Application Priority Data
Nov. 2, 2022 (KR) 10-2022-0144574

(51) Int. Cl. G02F 1/1676; G02B 26/08; G02F 1/167

(52) U.S. Cl. CPC G02F 1/1676; G02B 26/08; G02F 1/167; G02F 2001/1678

(57) ABSTRACT

A light path control device can include a first substrate, a first electrode disposed on the first substrate, a second substrate disposed on the first substrate, a second electrode disposed below the second substrate, a light conversion layer disposed between the first electrode and the second electrode and including a barrier part and a receptacle part arranged alternately therein, an adhesive layer disposed between the first electrode and the light conversion layer, and an insulation thin film disposed between the bather part and the adhesive layer.

### CROSS REFERENCE TO RELATED APPLICATION

The present application claims priority to Korean Patent Application No. 10-2022-0144574, filed on Nov. 2, 2022 in the Republic of Korea, the entire contents of which are hereby expressly incorporated by reference into the present application.

### BACKGROUND OF THE INVENTION

### Field of the Invention

The present invention relates to a light path control device and a manufacturing method thereof.

### Discussion of the Related Art

As an example of a light path control device, a dimming film can function as a light path control device by controlling the movement path of light depending on the incident angle of external light, blocking light in a certain direction, and transmitting light in another specific direction. Such dimming films are attached to display devices such as mobile phones, laptops, tablet PCs, and car navigation systems, and adjust the optical viewing angle when images are displayed, allowing for clear picture quality to be achieved within a specific viewing angle.

Recently developed switchable dimming films can turn the viewing angle control mode on or off according to a user's environment. The switchable dimming films use electrically responsive particles dispersed in a solvent to block or open the light path by controlling the dispersion and aggregation of the particles. Using such switchable dimming films, it is possible to implement a private mode and a share mode on display devices.

### SUMMARY OF THE INVENTION

The embodiments of the present invention provide a light path control device and a manufacturing method thereof capable of preventing the movement of ionic impurities that can be caused by leakage current. In the present application, the phrase “ionic impurities” can also be referred to as “ion impurities.”

The embodiments of the present invention provide a light path control device and a manufacturing method thereof capable of preventing migration and degradation of electrodes that can be caused by ionic impurities in conductive materials.

A light path control device according to an embodiment of the present invention can include a first substrate, a first electrode disposed on the first substrate, a second substrate disposed on the first substrate, a second electrode disposed below the second substrate, a light conversion layer disposed between the first electrode and the second electrode and including a barrier part and a receptacle part arranged alternately therein, an adhesive layer disposed between the first electrode and the light conversion layer, and an insulation thin film interposed between the barrier part and the adhesive layer.

The insulation thin film can be formed by including at least one of silicon nitride (SiN), titanium dioxide (TiO2), and silicon dioxide (SiO2).

The insulation thin film can be formed on a region of a bottom surface and an outer wall of the barrier part.

The adhesive layer can be, at least a part thereof, embedded inward of the receptacle part.

The insulation thin film can be interposed between the barrier part and the embedded adhesive layer on a part of the outer wall of the barrier part.

The first height of the embedded adhesive layer can from the bottom surface of the barrier part be equal to or greater than the second height of the insulation thin film formed on the outer wall of the barrier part from the bottom surface of the barrier part.

The receptacle part can include dispersion liquid and floating particles dispersed in the dispersion liquid.

The receptacle part can be formed to be spaced at a predetermined distance apart from the second electrode in the light conversion layer.

A method of manufacturing a light path control device according to an embodiment of the present invention can include forming a first electrode and an adhesive layer on a first substrate sequentially, forming a second electrode on a second substrate, fabricating a light conversion layer, and bonding the first substrate and the second substrate while the light conversion layer is interposed between the first substrate and the second substrate, wherein fabricating the light conversion layer can include forming an optical curable resin layer on a parent substrate, forming a barrier part of a tooth shape and a receptacle part arranged alternately with the barrier part by patterning the optical curable resin layer, forming an insulation thin film on the barrier part, and removing the parent substrate.

Forming the insulation thin film can include sputtering firstly by injecting a liquid or gas as the material of the insulation thin film from the bottom while the light conversion layer is tilted to one side, and sputtering secondly by injecting the liquid or gas as the material of the insulting film from the bottom while the light conversion layer is tilted to the opposite side.

The insulation thin film can be formed on a region of a bottom surface and one outer wall of the barrier part after the first sputtering, and an opposite region at the bottom surface and the opposite outer wall of the barrier part after the second sputtering.

The insulation thin film can be a material including at least one of silicon nitride (SiN), titanium dioxide (TiO2), and silicon dioxide (SiO2).

The adhesive layer can be, at least a part thereof, embedded inward of the receptacle part during the bonding.

The insulation thin film can be interposed between the barrier part and the embedded adhesive layer on a part of the outer wall of the barrier part.

The first height of the embedded adhesive layer can from the bottom surface of the barrier part can be equal to or less than the second height of the insulation thin film formed on the outer wall of the barrier part from the bottom surface of the barrier part.

The method can further include forming an injection hole overlapping, at least a part thereof, with the receptacle part by irradiating a laser on the first substrate after forming the first electrode and the adhesive layer on the first substrate, and injecting dispersion liquid including floating particles into the receptacle part through the injection hole after the bonding.

### BRIEF DESCRIPTION OF THE DRAWINGS

The embodiments of the present invention will become more fully understood from the detailed description given hereinbelow and the accompanying drawings which are given by way of illustration only, and thus are not limitative of the embodiments of the present invention.

FIG. 1 is a perspective view of a light path control device according to an example of the present invention;

FIG. 2 is a schematic cross-sectional view illustrating the light path control device of FIG. 1 in a private mode;

FIG. 3 is a schematic cross-sectional view illustrating the light path control device of FIG. 1 in a share mode;

FIG. 4 is a schematic cross-sectional view for explaining occurrence of leakage current in the light path control device of FIG. 1;

FIG. 5 is a cross-sectional view illustrating a light path control device according to an embodiment of the present invention;

FIG. 6 is an enlarged view of an area AA in FIG. 5; and

FIGS. 7 to 15 are diagrams illustrating a method of manufacturing a light path control device according to one or more embodiments of the present invention.

### DETAILED DESCRIPTION OF THE EMBODIMENTS

Hereinafter, embodiments of the present invention will be described with reference to accompanying drawings. In the specification, when a component (or area, layer, part, etc.) is mentioned as being “on top of,” “connected to,” or “coupled to” another component, it means that it can be directly connected/coupled to the other component, or a third component or additional components can be placed between them.

The same reference numerals refer to the same components. In addition, in the drawings, the thickness, proportions, and dimensions of the components are exaggerated for effective description of the technical content. The expression “and/or” is taken to include one or more combinations that can be defined by associated components.

The terms “first,” “second,” etc. are used to describe various components, but the components should not be limited by these terms. The terms are used only for distinguishing one component from another component and may not define order or sequence. For example, a first component can be referred to as a second component and, similarly, the second component can be referred to as the first component, without departing from the scope of the present invention. As used herein, the singular forms are intended to include the plural forms as well, unless the context clearly indicates otherwise.

The terms such as “on,” “over,” “under,” “below,” “lower,” “above,” “upper,” etc. are used to describe the relationship of components depicted in the drawings. The terms are relative concepts and are described based on the direction indicated on the drawing. The terms such as “on,” “above,” “over,” “under,” “below,” etc. are used to describe positional relationships between two components/layers, and are used to indicate that there are one or more additional components/layers between the two components/layers.

It will be further understood that the terms such as “comprises,” “includes,” “has,” and the like are intended to specify the presence of stated features, numbers, steps, operations, components, parts, or a combination thereof but are not intended to preclude the presence or possibility of one or more other features, numbers, steps, operations, components, parts, or combinations thereof.

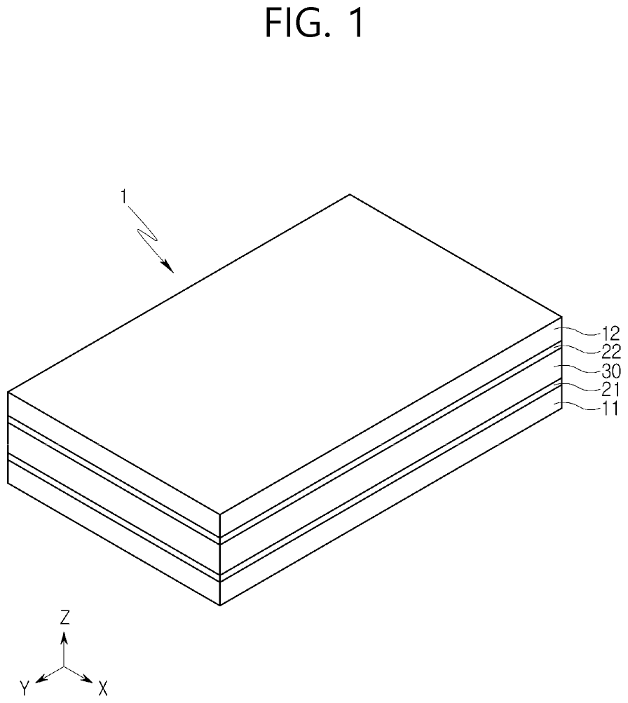

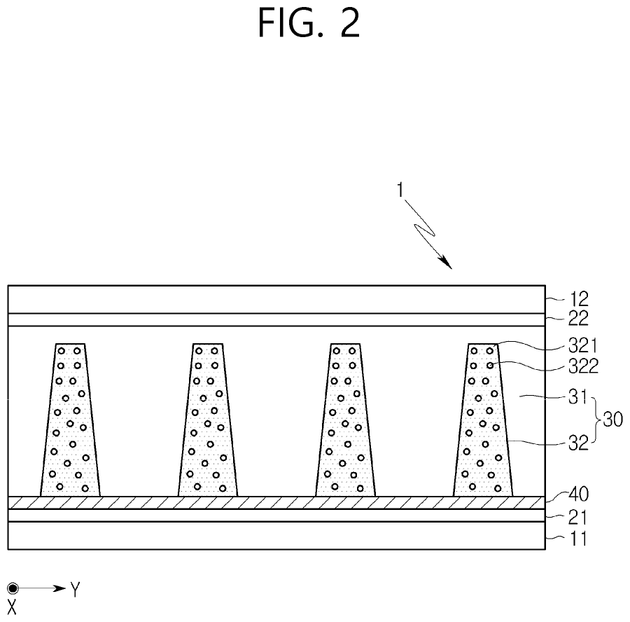

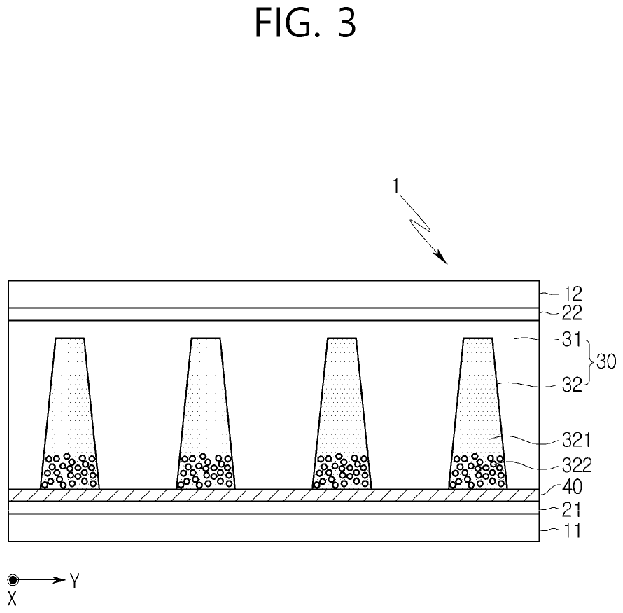

FIG. 1 is a perspective view of a light path control device 1 according to an example of the present invention. FIG. 2 is a schematic cross-sectional view illustrating the light path control device 1 in a private mode. FIG. 3 is a schematic cross-sectional view illustrating the light path control device 1 in a share mode.

With reference to FIGS. 1 to 3, the light path control device 1 can include a first substrate 11, a second substrate 12, a first electrode 21, a second electrode 22, and a light conversion layer 30.

The first substrate 11 serves as a base material for the light path control device 1 and can be a transparent substrate. The first substrate 11 can be a rigid substrate including glass or tempered glass, or a flexible substrate made of a plastic material. For example, the first substrate 11 can be a flexible polymer film made of one of polyethylene terephthalate (PET), polycarbonate (PC), acrylonitrile-butadiene-styrene copolymer (ABS), polymethyl methacrylate (PMMA), polyethylene naphthalate (PEN), polyether sulfone (PES), cyclic olefin copolymer (COC), triacetylcellulose (TAC), polyvinyl alcohol (PVA), Polyimide (PI), and polystyrene (PS). However, the material of the first substrate 11 is not limited to the above materials.

The first electrode 21 can be disposed on one surface (e.g., the upper surface) of the first substrate 11. The first electrode 21 is interposed between the first substrate 11 and the second substrate 12 to be described later. The first electrode 21 can be disposed on the first substrate 11 in the form of a planar electrode or a patterned electrode.

The first electrode 21 can be composed of a transparent conductive material. For example, the first electrode 21 can be formed of indium tin oxide (ITO), indium zinc oxide (IZO), copper oxide, tin oxide, zinc oxide (ZnO), or titanium oxide. In an embodiment, the optical transmittance of the first electrode 21 can be about 80% or more. In this case, the first electrode 21 can be invisible from the outside and improve the optical transmittance, leading to an enhancement of the brightness of the display device including the light path control device 1.

In another embodiment, the first electrode 21 can include various metals to reduce the resistance. For example, the first electrode 21 can include at least one of chrome (Cr), nickel (Ni), copper (Cu), aluminum (Al), silver (Ag), molybdenum (Mo), gold (Au), titanium (Ti), and alloys thereof.

The second substrate 12 can be disposed on the first substrate 11. The second substrate 12 can be a light-transmissive substrate and can be composed of a material identical or similar to that of the first substrate 11.

The first electrode 22 can be disposed on one surface (e.g., the bottom surface) of the first substrate 12. The second electrode 22 is interposed between the first substrate 11 and the second substrate 12. The second electrode 22 can be disposed on the bottom surface of the second substrate 12 in the form of a planar electrode or a patterned electrode.

The second electrode 22 can be composed of a transparent conductive material and can include various metals for implementing low resistance. The second electrode 22 can be composed of a material identical or similar to that of the first electrode 21.

The second electrode 22 is disposed to, at least partially or entirely, overlap with or be adjacent to the first electrode 21. Accordingly, when a voltage is applied to the first electrode 21 and the second electrode 22, an electric field can be formed therebetween.

The light conversion layer 30 can be interposed between the first substrate 11 and the second substrate 12. The light conversion layer 30 can include a barrier part 31 and a receptacle part 32. In detail, the light conversion layer 30 can include a receptacle part 32 partitioned into multiple areas by a barrier part 31. For example, the receptacle part 32 is delimited by the barrier part 31 such that the outer wall of the barrier part 31 forms the inner wall of the receptacle part 32.

Within the light conversion layer 30, the receptacle part 32 extends lengthwise in a first direction (e.g., X direction). Within the light conversion layer 30, the barrier part 31 and the receptacle part 32 can be alternately arranged in a second direction (e.g., Y direction). Here, the barrier part 31 and the receptacle part 32 can have the same or different widths in the second direction Y.

The barrier part 31 can be composed of a transparent and optically transmissive material. The barrier part 31 can be made of conductive materials. For example, the barrier part 31 can be composed of optical curable resins such as ultraviolet (UV) resin and photoresist resin, or be composed of materials such as urethane resin, acrylic resin, and the like. The barrier part 31 can transmit light entering from the first substrate 11 or the second substrate 12 in the opposite direction.

The receptacle part 32 can have equal or different width at the top and bottom. In an embodiment, the receptacle part 32 can be formed in a trapezoidal shape such that the width at the bottom adjacent to the first substrate 11 is wider than the width at the top adjacent to the second substrate 12, as illustrated. However, this embodiment is not limited thereto. The receptacle part 32 can be formed to be spaced apart at a constant interval in a height direction (e.g., Z direction or direction perpendicular to both X and Y) from the second electrode 22 within the light conversion layer 30. For example, the second electrode 22 is in direct contact with the barrier part 31.

The receptacle part 32 is arranged to overlap, at least one region thereof, with the first electrode 21. The receptacle part 32 is also arranged to overlap, at least one region thereof, with the second electrode 22.

The receptacle part 32 can include dispersion liquid 321 and floating particles 322 dispersed within the dispersion liquid 321. For example, the receptacle part 32 can be filled with the dispersion liquid 321, in which floating particles 322 can be dispersed.

The dispersion liquid 321 can be an insulating solvent that is transparent and has a low viscosity, and functions as a medium in which floating particles 322 are dispersed. For example, the dispersion liquid 321 can include at least one of Halocarbon-based oil, paraffin-based oil, and isopropyl alcohol.

The floating particles 322 can be colored electrically responsive particles, such as black particles. The floating particles 322 can be, but is not limited to, carbon black particles. The receptacle part 32 can be electrically connected to the first and second electrodes 21 and 22, and the polarized floating particles 322 can be controlled in their arrangement state based on the voltage difference between the first and second electrodes 21 and 22. Depending on the arrangement state of the floating particles 322, the light conversion layer 30 can implement a transparent mode and a shading mode.

In detail, when no voltage is applied to the first and second electrodes 21 and 22, the floating particles 322 are uniformly dispersed within the dispersion liquid 321, as shown in FIG. 2, to implement the shading mode that blocks the transmission of external light. In this case, the external light incident to the barrier part 31 can pass through the light conversion layer 30 to be visible from the front of the light path control device 1. For example, the light path control device 1 can implement a private mode that opens the view for a predetermined viewing angle (e.g., the front viewing angle) and blocks the view for other viewing angles (e.g., the side viewing angle).

When a voltage is applied to at least one of the first and second electrodes 21 and 22, the polarized floating particles 322 can be moved in the direction of the first electrode 21 or the second electrode 22 by the electric field, as shown in FIG. 3. Here, the direction of movement of the floating particles 322 can be controlled based on the polarity (negative or positive) of the floating particles 322 and the relative magnitude of the voltage applied to the first electrode 21 and the second electrode 22.

When the floating particles 322 aggregate around the first electrode 21 or the second electrode 22, the external light can pass through the barrier part 31 and the receptacle part 32, implementing the transparent mode. For example, the light path control device 1 can implement a share mode that opens up the view for both the front and the sides.

An adhesive layer 40 can be additionally disposed between the light conversion layer 30 and the first electrode 21. The adhesive layer 40 is formed on the first electrode 21 to improve coating and adhesion, and to seal the dispersion liquid 321 injected into the receptacle part 32. The adhesive layer 40 can be a transparent adhesive such as optical clear adhesive (OCA), optical curable resin (OCR).

In an embodiment, a primer can be further disposed between the light conversion layer 30 and the second electrode 22. The primer can be a conductive primer and can be provided to improve the adhesion between the light conversion layer 30 and the second electrode 22. The primer can include a curable resin that cures by energy such as heat, ultraviolet rays, and electron rays. For example, the curable resins can include, but is not limited to, silicone resins, acrylic resins, methacrylic resins, epoxy resins, melamine resins, polyester resins, and urethane resins.

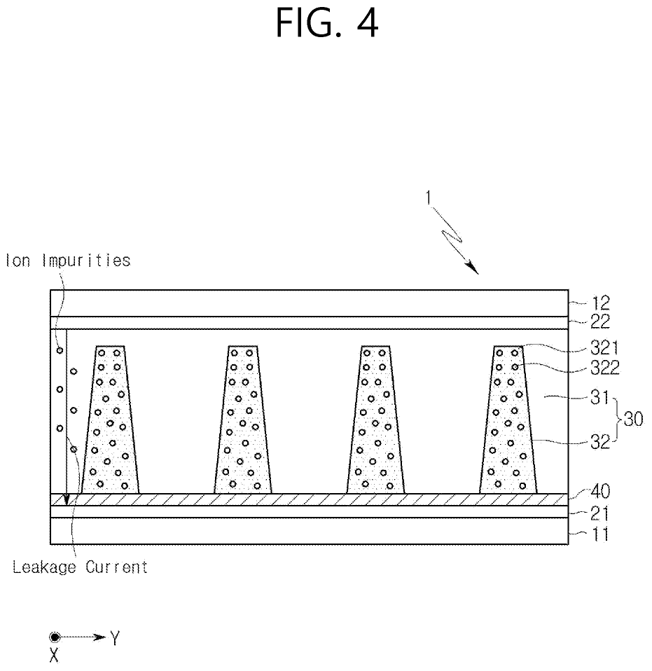

FIG. 4 is a schematic cross-sectional view for explaining occurrence of leakage current in the light path control device 1.

In the light path control device 1 according to an embodiment, when implementing the share mode, at least one of the first electrode 21 and the second electrode 22 is applied with voltage. As a result, an electric field is formed between the first and second electrodes 21 and 22.

In this case, leakage current penetrating through the bather part 31 can occur in a direction corresponding to the electric field. The leakage current can flow in the direction from the second electrode 22 to the first electrode 21 or in the opposite direction depending on the polarity of the voltage applied to the electrodes 21 and 22. In the disclosed embodiment, the leakage current flows in the direction from the second electrode 22 to the first electrode 21.

During the penetration of the leakage current through the barrier part 31, ion impurities within the barrier part 31 can be transferred to the first electrode 21. The ion impurities can induce ion migration to the first electrode 21, which can cause degradation such as yellowing and resistance increase.

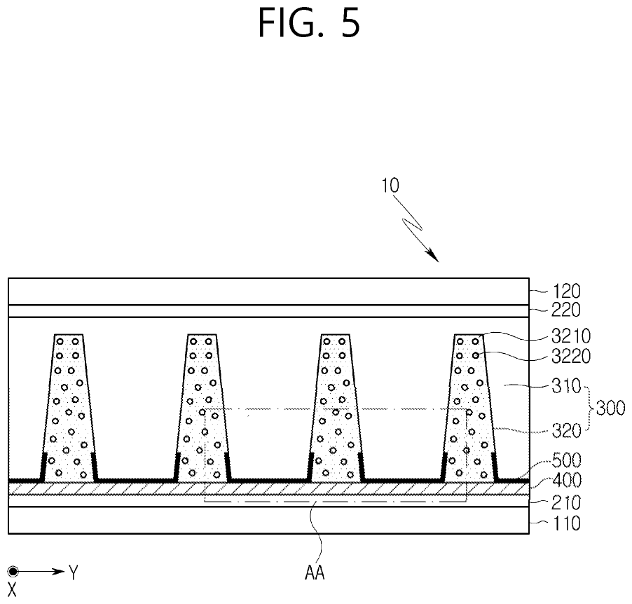

Therefore, according to the embodiments of the present invention, electrode damage which can be caused due to leakage current during the operation of a light path control device can be addressed or prevented by a light path control device of the present invention, which will be described referring to FIGS. 5-15. All components of each light path control device according to all embodiments of the present invention are operatively coupled and configured.

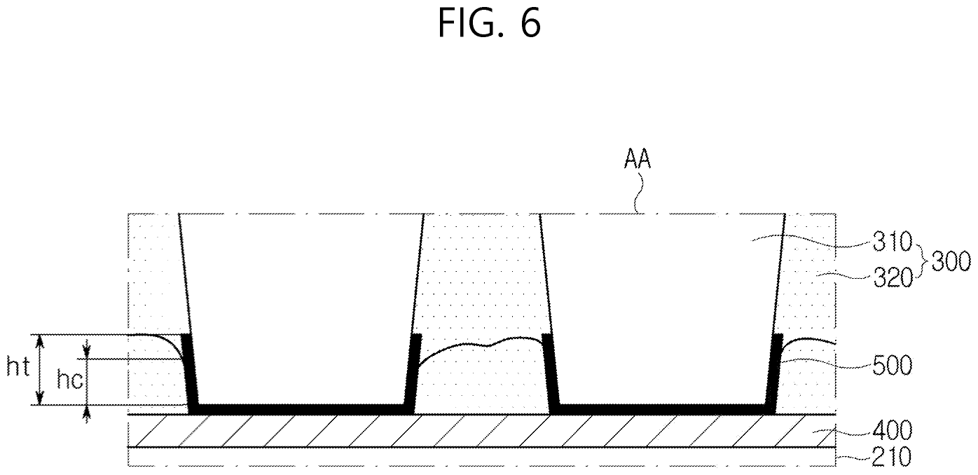

FIG. 5 is a cross-sectional view illustrating a light path control device according to an embodiment of the present invention. FIG. 6 is an enlarged view of an area AA in FIG. 5.

With reference to FIG. 5, a light path control device 10 can include a first substrate 110, a second substrate 120, a first electrode 210, a second electrode 220, and a light conversion layer 300.

The first substrate 110 serves as a base material for the light path control device 1 and can be a transparent substrate. The first substrate 110 can be a rigid substrate including glass or tempered glass, or a flexible substrate made of a plastic material. For example, the first substrate 110 can be a flexible polymer film made of one of polyethylene terephthalate (PET), polycarbonate (PC), acrylonitrile-butadiene-styrene copolymer (ABS), polymethyl methacrylate (PMMA), polyethylene naphthalate (PEN), polyether sulfone (PES), cyclic olefin copolymer (COC), triacetylcellulose (TAC), polyvinyl alcohol (PVA), Polyimide (PI), and polystyrene (PS). However, the material of the first substrate 110 is not limited thereto.

The first electrode 210 can be disposed on one surface (e.g., the upper surface) of the first substrate 110. The first electrode 210 is interposed between the first substrate 110 and the second substrate 120 to be described later. The first electrode 210 can be disposed on the first substrate 110 in the form of a planar electrode or a patterned electrode.

The first electrode 210 can be composed of a transparent conductive material. For example, the first electrode 210 can be formed of indium tin oxide (ITO), indium zinc oxide (IZO), copper oxide, tin oxide, zinc oxide (ZnO), or titanium oxide. In an embodiment of the present invention, the optical transmittance of the first electrode 210 can be about 80% or more. In this case, the first electrode 210 can be invisible from the outside and improve the optical transmittance, leading to an enhancement of the brightness of the display device including the light path control device 10.

In another embodiment of the present invention, the first electrode 210 can include various metals to reduce the resistance. For example, the first electrode 210 can include at least one of chrome (Cr), nickel (Ni), copper (Cu), aluminum (Al), silver (Ag), molybdenum (Mo), gold (Au), titanium (Ti), and alloys thereof.

The second substrate 120 can be disposed on the first substrate 110. The second substrate 120 can be a light-transmissive substrate and can be composed of a material identical or similar to that of the first substrate 110.

The first electrode 220 can be disposed on one surface (e.g., the bottom surface) of the first substrate 120. The second electrode 220 is interposed between the first substrate 110 and the second substrate 120. The second electrode 220 can be disposed on the bottom surface of the second substrate 120 in the form of a planar electrode or a patterned electrode.

The second electrode 220 can be composed of a transparent conductive material and can include various metals for implementing low resistance. The second electrode 220 can be composed of a material identical or similar to that of the first electrode 210.

The second electrode 220 is disposed to, at least a part or entirely, overlap with or be adjacent to the first electrode 210. Accordingly, when a voltage is applied to the first electrode 210 and the second electrode 220, an electric field can be formed between them.

The light conversion layer 300 can be interposed between the first substrate 110 and the second substrate 120. The light conversion layer 300 can include a barrier part 310 and a receptacle part 320. In detail, the light conversion layer 300 can include a receptacle part 320 partitioned into multiple areas by a barrier part 310. For example, the receptacle part 320 is delimited by the barrier part 310 such that the outer wall of the barrier part 310 forms the inner wall of the receptacle part 320.

Within the light conversion layer 300, the receptacle part 320 extend lengthwise in a first direction X (e.g., X direction). Within the light conversion layer 300, the barrier part 310 and the receptacle part 320 can be alternately arranged in a second direction Y (e.g., Y direction). Here, the barrier part 310 and the receptacle part 320 can have the same or different widths in the second direction Y.

The barrier part 310 can be composed of a transparent and optically transmissive material. The barrier part 310 can be made of conductive materials. For example, the barrier part 310 can be composed of optical curable resins such as ultraviolet (UV) resin and photoresist resin, or be composed of materials such as urethane resin, acrylic resin, and the like. The barrier part 310 can transmit light entering from the first substrate 110 or the second substrate 120 in the opposite direction.

The receptacle part 320 can have equal or different width at the top and bottom. In an embodiment of the present invention, the receptacle part 320 can be formed in a trapezoidal shape such that the width at the bottom adjacent to the first substrate 110 is wider than the width at the top adjacent to the second substrate 120, as illustrated. However, this embodiment is not limited thereto. The receptacle part 320 can be formed to be spaced apart at a constant interval in a height direction (i.e., a direction perpendicular to both X and Y, e.g., Z direction) from the second electrode 220 within the light conversion layer 300. For example, the second electrode 220 is in direct contact with the barrier part 310.

The receptacle part 320 is arranged to overlap, at least one region thereof, with the first electrode 210. The receptacle part 320 is also arranged to overlap, at least one region thereof, with the second electrode 220.

The receptacle part 320 can include dispersion liquid 3210 and floating particles 3220 dispersed within the dispersion liquid 3210. For example, the receptacle part 320 can be filled with dispersion liquid 3210, in which floating particles 3220 can be dispersed.

The dispersion liquid 3210 can be an insulating solvent that is transparent and has a low viscosity, and functions as a medium in which floating particles 3220 are dispersed. For example, the dispersion liquid 3210 can include at least one of Halocarbon-based oil, paraffin-based oil, and isopropyl alcohol.

The floating particles 3220 can be colored electrically responsive particles, such as black particles. The floating particles 3220 can be, but is not limited to, carbon black particles. The receptacle part 320 can be electrically connected to the first and second electrodes 210 and 220, and the polarized floating particles 3220 can be controlled in their arrangement state based on the voltage difference between the first and second electrodes 210 and 220. Depending on the arrangement state of the floating particles 3220, the light conversion layer 300 can implement a transparent mode and a shading mode.

An adhesive layer 400 can be additionally disposed between the light conversion layer 300 and the first electrode 210. The adhesive layer 400 is formed on the first electrode 210 to improve coating and adhesion, and to seal the dispersion liquid 3210 injected into the receptacle part 320. The adhesive layer 400 can be a transparent adhesive such as optical clear adhesive (OCA), optical curable resin (OCR).

By applying pressure to the first substrate 110 and the light conversion layer 300 in the state where the adhesive layer 400 is interposed therebetween, the first substrate 110 and the light conversion layer 300 can be bonded to each other through the adhesive layer 400.

During the pressing, the adhesive layer 400 in the uncured state can be at least partially embedded inward of the receptacle part 320, which has a relatively low-density, as shown in FIG. 6. As a result, the adhesive layer 400 can come into contact with a certain area of the inner wall of the receptacle part 320 (i.e., the outer wall of the barrier part 310). The contact area between the adhesive layer 400 and the inner wall of the receptacle part 320 is determined by the magnitude and/or duration of the applied pressure. In FIG. 6, the height of the embedding of the adhesive layer 400 from the bottom surface of the barrier part 310 in contact with the adhesive layer 400 is referred to as a first height hc.

In an embodiment of the present invention, a primer can be further disposed between the light conversion layer 300 and the second electrode 220. The primer can be a conductive primer and can be provided to improve the adhesion between the light conversion layer 300 and the second electrode 220. The primer can include a curable resin that cures by energy such as heat, ultraviolet rays, and electron rays. For example, the curable resins can include, but are not limited to, silicone resins, acrylic resins, methacrylic resins, epoxy resins, melamine resins, polyester resins, and urethane resins.

In this embodiment, the light path control device 10 can further include an insulation thin film 500 interposed between the light conversion layer 300 and the adhesive layer 400, more specifically, between the barrier part 310 of the light conversion layer 300 and the first electrode 210. The insulation thin film 500 can be formed on the interface where the barrier part 310 contacts the adhesive layer 400. For example, the insulation thin film 500 can be formed on the bottom surface of the barrier part 310 in contact with the adhesive layer 400. As described with reference to FIG. 6, when the adhesive layer 400 is embedded inward of the receptacle part 320 and in contact with the outer wall of the barrier part 310, the insulation thin film 500 can be formed on a part of the outer wall of the barrier part 310 defining the receptacle part 320 to be interposed between the outer wall of the barrier part 310 and the embedded adhesive layer 400.

In FIG. 6, the height of the insulation thin film 500 formed on the outer wall of the barrier part 310, from the bottom surface in contact with the adhesive layer 400, is referred to as a second height ht. In one embodiment of the present invention, the second height ht to which the insulation thin film 500 is formed can be equal to or greater than the first height hc to which the adhesive layer 400 is in contact. In other words, the first height hc is equal to or less than the second height ht. Accordingly, the insulation thin film 500 can ensure reliability in insulation between the barrier wall 310 and the adhesive layer 400.

The first height hc and the second height ht can be the same or different among the barrier parts 310. However, in at least some of the barrier parts 310, the condition of the first height hc equal to or less than the second height ht can be satisfied.

The greater the contact area between the insulation thin film 500 and the adhesive layer 400, the higher the surface resistance of the adhesive layer 400 can become. In an embodiment of the present invention, the surface resistance of the adhesive layer 400 at the interface with the insulation thin film 500 can be about 10⁹ ohm/sq. However, this embodiment is not limited thereto.

The insulation thin film 500 is composed of a transparent material, preventing the light path from being blocked or the field of view from being restricted by the insulation thin film 500. The insulation thin film 500 can be formed by including at least one of silicon nitride (SiN), titanium dioxide (TiO2), and silicon dioxide (SiO2), for example.

In an embodiment of the present invention, the insulation thin film 500 can be formed by a mask-free process using gradient deposition. For example, the insulation thin film 500 can be formed on the barrier part 310 by a sputtering method before the dispersion liquid 321 and floating particles 322 are injected into the receptacle part 320. Hereinafter, the method for forming the insulation thin film 500 is described in more detail with reference to the drawings.

As described above, the insulation thin film 500 is formed at the interface between the barrier part 310 of the light conversion layer 300 and the adhesive layer 400. For example, the insulation thin film 500 insulates between the light conversion layer 300 and the first electrode 210. When the light path control device 10 operates to form an electric field between the first and second electrodes 210 and 220, leakage current can occur in the direction from the second electrode 220 to the first electrode 210 via the barrier part 310. The insulation thin film 500 insulates between the barrier part 310 and the first electrode 210, blocking the leakage current from reaching the first electrode 210. As the leakage current is blocked, it is possible to prevent the first electrode 210 from being degraded by migration caused by the leakage current.

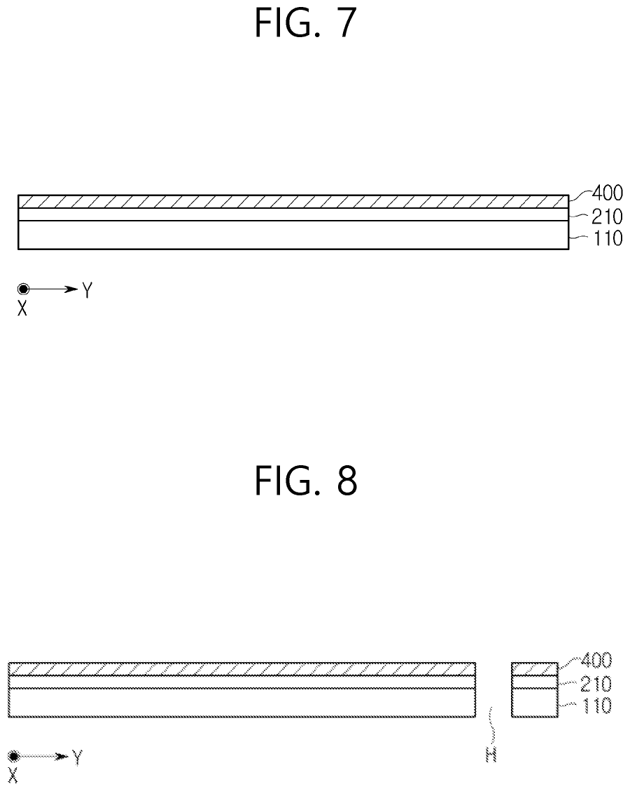

FIGS. 7 to 15 are diagrams illustrating a method of manufacturing a light path control device according to one or more embodiments of the present invention.

First, with reference to FIG. 7, the first electrode 210 is formed on the first substrate 110. Next, the adhesive layer 400 is formed on the first substrate 110. The adhesive layer 400 can cover the entire surface of the first substrate 110.

Afterward, a process of puncturing an injection hole H as shown in FIG. 8 is performed. The puncturing process can be performed by irradiating a laser on the lower or upper surface of the first substrate 110. The injection hole H can be formed at a position that overlaps at least partly with the receptacle part 320 of the light conversion layer 300 to be formed later. As necessary, the injection hole H can also be formed after the process of laminating the light conversion layer 300.

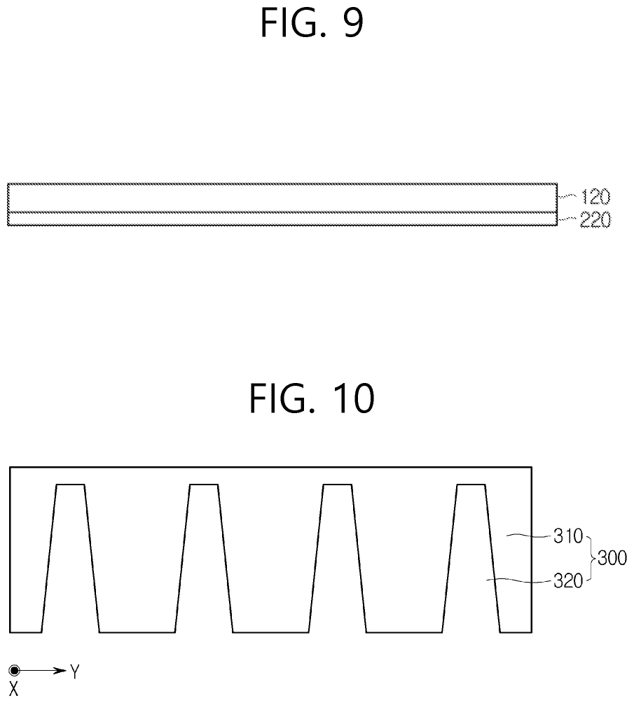

Afterwards, the second electrode 220 can be formed on the second substrate 120 as shown in FIG. 9. According to an embodiment of the present invention, a primer can be further formed on the second substrate 120.

Afterward, the process of manufacturing the light conversion layer 300 can be performed. For example, as shown in FIG. 10, an optical curable resin layer can be formed as a material for the barrier part 310 on a parent substrate and then patterned to form the barrier part 310 and the receptacle part 320 in a tooth shape. By removing the parent substrate afterward, the structure shown in FIG. 10 is formed.

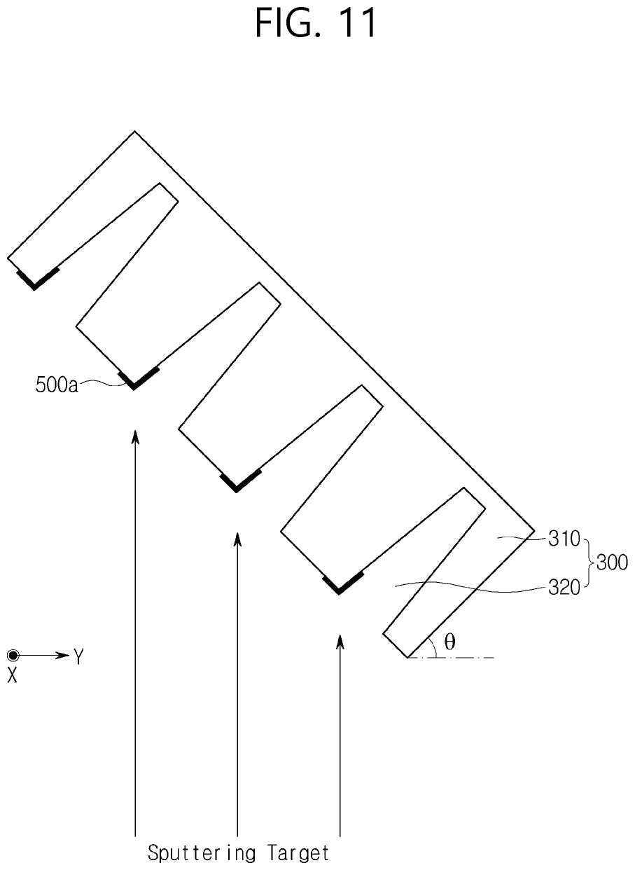

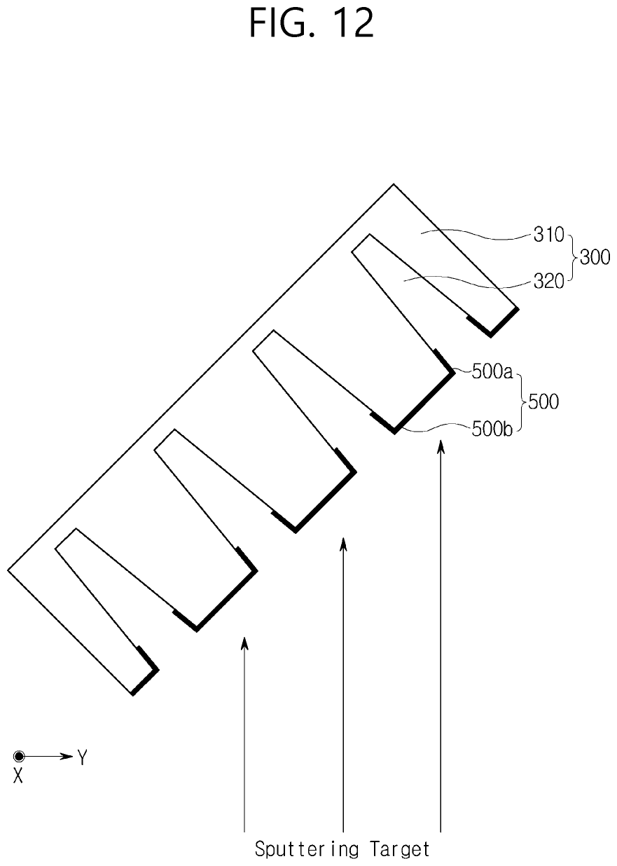

Then, the insulation thin film 500 is formed as shown in FIGS. 11 and 12. In an embodiment of the present invention, the insulation thin film 500 can be formed through a sputtering process. First, as shown in FIG. 11, the light conversion layer 300 is tilted to one side, and a liquid or gas (target) material for the insulation layer 500 is injected from the bottom. Due to the tilt of the light conversion layer 300, a part of the bottom surface and a part of the outer wall of the barrier part 310, which are not blocked by neighboring teeth, are exposed in the direction of injection. As a result, after the sputtering process, an insulation thin film 500a can be formed on a part of the bottom surface and a part of the outer wall of the bather part 310.

Afterwards, the same sputtering process is performed with the light conversion layer 300 tilted to the opposite side, as shown in FIG. 12. As a result, after the sputtering process, an insulation thin film 500b can be formed on another part of the bottom surface and another part of the outer wall of the barrier part 310.

The angle θ at which the light conversion layer 300 is tilted during the sputtering process can be adjusted, taking into account the second height ht to which the light conversion layer 300 is formed (refer to FIG. 6) and the first height hc to which the adhesive layer 400 is embedded (refer to FIG. 6).

The fabrication process of the light conversion layer 300 can be performed prior to or in parallel with the manufacturing process of the first substrate 110 and second substrate 120. The timing of the fabrication process of the light conversion layer 300 is not limited as long as before the subsequent lamination process.

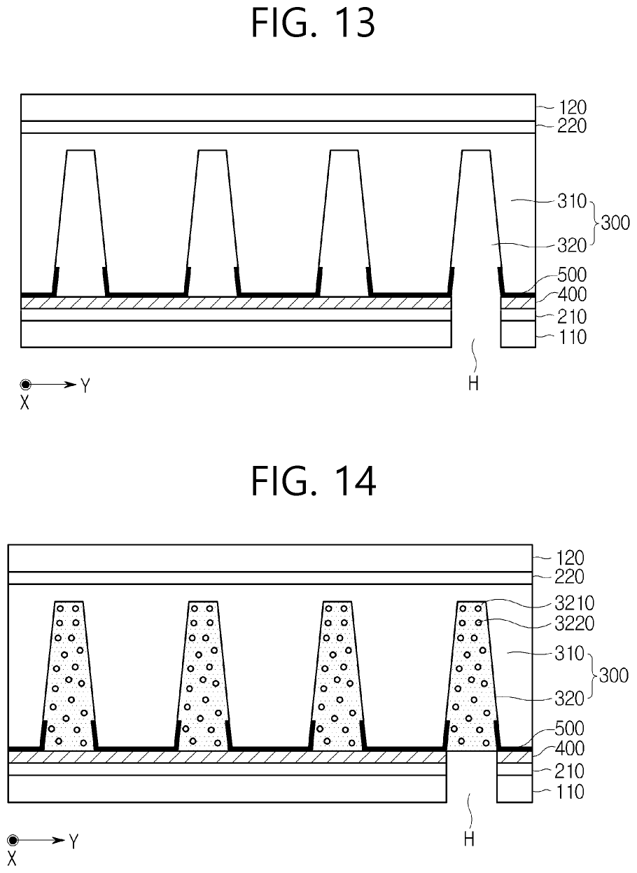

Afterward, as shown in FIG. 13, the first and second substrates 110 and 120 can be bonded together while the light conversion layer 300, in which the dispersion liquid 3210 is not injected into the receptacle part 320, is interposed therebetween. The first and second substrates 110 and 120 can be bonded to each other via the adhesive layer 400. After bonding, the receptacle part 320 of the light conversion layer 300 can at least partly connect to the injection hole H.

Afterward, the dispersion liquid 3210 containing floating particles 3220 is injected into the light conversion layer 300, as shown in FIG. 14. The dispersion liquid 3210 can be injected through the injection hole H which connects with the receptacle part 320.

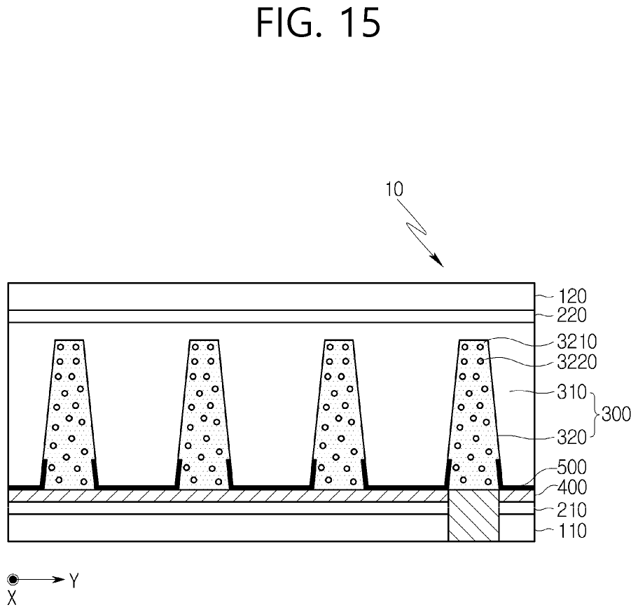

Afterward, a sealing material can be injected into the injection hole H and cured, as shown in FIG. 15. As necessary, additional processes such as damming and/or sealing or cutting processes can be performed to seal the edges of the light path control device 10.

A light path control device and a manufacturing method thereof according to embodiments of the present invention are capable of preventing current leakage during operation, thereby preventing yellowing and resistance increase of electrodes.

Although embodiments of this invention have been described above with reference to the accompanying drawings, it will be understood that the technical configuration of the this invention described above can be implemented in other specific forms by those skilled in the art without changing the technical concept or essential features of the present invention. Therefore, it should be understood that the embodiments described above are exemplary and not limited in all respects. Furthermore, the scope of the present invention is defined by the claims set forth below, rather than the detailed description above. In addition, it should be understood that all modifications or variations derived from the meaning and scope of the claims and their equivalent concept are included within the scope of the this invention.

What is claimed is:

1. A light path control device comprising:
a first substrate;
a first electrode disposed on the first substrate;
a second substrate disposed on the first substrate;
a second electrode disposed below the second substrate;
an light conversion layer disposed between the first electrode and the second electrode, and including a barrier part and a receptacle part arranged alternately therein;
an adhesive layer disposed between the first electrode and the light conversion layer; and
an insulation thin film interposed between the barrier part and the adhesive layer.

2. The light path control device of claim 1, wherein the insulation thin film includes at least one of silicon nitride (SiN), titanium dioxide (TiO2), and silicon dioxide (SiO2).

3. The light path control device of claim 1, wherein the insulation thin film is disposed on a region of a bottom surface and an outer wall of the barrier part.

4. The light path control device of claim 3, wherein at least a part of the adhesive layer is embedded inward of the receptacle part.

5. The light path control device of claim 4, wherein the insulation thin film is interposed between the barrier part and the embedded adhesive layer on a part of the outer wall of the barrier part.

6. The light path control device of claim 5, wherein the embedded adhesive layer has a first height from the bottom surface of the barrier part, and the insulation thin film disposed on the outer wall of the bather part has a second height from the bottom surface of the barrier part, the first height being equal to or less than the second height.

7. The light path control device of claim 1, wherein the receptacle part comprises dispersion liquid and floating particles dispersed in the dispersion liquid.

8. The light path control device of claim 1, wherein the receptacle part is disposed to be spaced at a predetermined distance apart from the second electrode in the light conversion layer.

9. A method of manufacturing a light path control device, the method comprising:
forming a first electrode and an adhesive layer on a first substrate sequentially;
forming a second electrode on a second substrate;
forming a light conversion layer; and
bonding the first substrate and the second substrate while the light conversion layer is interposed between the first substrate and the second substrate,
wherein the forming the light conversion layer comprises:
forming an optical curable resin layer on a parent substrate;
forming a barrier part of a tooth shape and a receptacle part arranged alternately with the barrier part by patterning the optical curable resin layer;
forming an insulation thin film on the bather part; and
removing the parent substrate.

10. The method of claim 9, wherein the forming the insulation thin film comprises:
sputtering firstly by injecting a liquid or gas as a material of the insulation thin film from the bottom while the light conversion layer is tilted to one side; and
sputtering secondly by injecting the liquid or gas as the material of the insulting film from the bottom while the light conversion layer is tilted to the opposite side.

11. The method of claim 10, wherein the insulation thin film is formed on a region of a bottom surface and one outer wall of the barrier part after the first sputtering, and an opposite region at the bottom surface and the opposite outer wall of the barrier part after the second sputtering.

12. The method of claim 10, wherein the insulation thin film includes a material having at least one of silicon nitride (SiN), titanium dioxide (TiO2), and silicon dioxide (SiO2).

13. The method of claim 9, wherein at least a part of the adhesive layer is embedded inward of the receptacle part during the bonding.

14. The method of claim 13, wherein the insulation thin film is interposed between the barrier part and the embedded adhesive layer on a part of the outer wall of the barrier part.

15. The method of claim 14, wherein the embedded adhesive layer has a first height from the bottom surface of the barrier part, and the insulation thin film formed on the outer wall of the bather part has a second height from the bottom surface of the barrier part, the first height being equal to or less than the second height.

16. The method of claim 9, further comprising:
forming an injection hole overlapping, at least a part thereof, with the receptacle part by irradiating a laser on the first substrate after forming the first electrode and the adhesive layer on the first substrate; and
injecting dispersion liquid including floating particles into the receptacle part through the injection hole after the bonding.
